(19) United States
(12) Patent Application Publication
(10) Pub. No.: US 2017/0147471 A1
(43) Pub. Date: May 25, 2017

(54) ISOLATING PRODUCTION ENVIRONMENT DEBUGGING SESSIONS

(71) Applicant: Hewlett Packard Enterprise Development LP, Houston, TX (US)

(72) Inventors: Tomer Shadi, Yehud (IL); Adrian Dinita, Cluj-Napoca (RO); Avigail Oron, Petach Tikiva (IL)

(21) Appl. No.: 15/312,925

(22) PCT Filed: May 29, 2014
(86) PCT No.: PCT/US2014/039952

§ 371 Date: Nov. 21, 2016

(51) Int. Cl. G06F 11/36

(52) U.S. Cl. CPC G06F 11/3624

(57) ABSTRACT

Example implementations relate to isolating production environment debugging sessions. Some example implementations may include a runtime execution engine to execute, using a production environment, an original work flow corresponding to a unit of production environment source code. Some example implementations may also include a session initiation request engine to receive a request to perform a debugging session of a modified version of the unit of production environment source code. In some examples, the request may include a modified execution plan corresponding to a machine-readable translation of the modified version. Some example implementations may also include a debugging execution engine to execute the modified execution plan in isolation, the modified execution plan being executed in the production environment without altering at least one of the unit of production environment source code and the original work flow.

### BACKGROUND

During application development, changes to an application may be tested in a staging environment that attempts to simulate the production environment where the application is targeted to run. However, some changes that were verified in a staging environment may still fail when being promoted to the production environment. In such cases, the changes may need to be remotely debugged while the application source code is running in the production environment. During remote debugging, a developer may initiate execution of source code in a simplified runtime environment (e.g., a sandbox environment, authoring environment, etc.) on the developer's computing device, and track the source code's steps throughout the execution.

### BRIEF DESCRIPTION OF THE DRAWINGS

The following detailed description references the drawings, wherein:

FIG. 1 is a block diagram of an example system for isolating production environment debugging sessions consistent with disclosed implementations;

FIG. 2 is a block diagram of an example production environment debugging device consistent with disclosed implementations;

FIG. 3 is a block diagram of an example production environment debugging device consistent with disclosed implementations;

FIG. 4 is a flow chart of an example process for isolating production environment debugging sessions consistent with disclosed implementations;

FIG. 5 is a flow chart of an example process for creating modified object code consistent with disclosed implementations;

FIG. 6 is a flow chart of an example process for receiving a request to perform a debugging session of a modified version of a unit of production environment source code consistent with disclosed implementations;

FIG. 7 is a flow chart of an example process for executing modified object code in isolation consistent with disclosed implementations; and

FIG. 8 is an example of a user interface for displaying tracked debugging data consistent with disclosed implementations.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

As detailed above, a developer may debug source code using a simplified runtime environment on the developer's computing device. However, the production environment may be much more complex in terms of deployment (e.g., local and cross site cluster), security (e.g., access control and policies), integrations, performance (scaled up and out), and logging. Thus, to accurately predict the source code's behavior, a developer may desire to debug the source code in the production environment.

While developers may desire production environment source code debugging, traditional methods of debugging may simply simulate the production environment by having a copy of the production environment which is dedicated to the developers for testing purposes. However, due, for example, to budgetary restrictions, these test environments may not be exact copies of the production environment. Furthermore, debugging the source code in test environments may involve pushing modified source code directly into the test environment and executing it in the test environment. This push of source code may pose extra overhead on the testing and/or eliminate the ability to simultaneously test multiple changes of the same or similar source code coming from multiple developers. Accordingly, to accurately and efficiently debug source code, the debugging should be performed in a production environment in a way that does not change the production environment source code and in a way that allows multiple developers to debug source code changes of the same or similar source code simultaneously.

Examples disclosed herein provide isolated production environment debugging sessions. To this end, example implementations may execute, in a production environment, an original object code (e.g., an original work flow) corresponding to a unit of production environment source code. In some examples, the unit of production environment source code may be deployed in the production environment. Additionally, some example implementations may receive a request to perform a debugging session of a modified version of the production environment source code (“modified source code”), and the request may include a modified object code (e.g., a modified execution plan) corresponding to a machine-readable translation of the modified source code. For example, a developer may access the production environment source code, modify the source code, pack the modified source code as a single resource, transmit the single resource to a debugging device and/or compile the modified source code to create the modified object code, and transmit the modified object code to the production environment either before or after the debugging session request has been authenticated. Some example implementations may also executed the modified object code in isolation in the production environment. For example, the execution of the modified object code may be dedicated to the particular debugging session that initiated the debugging and/or without altering at least one of the source code and the original object code.

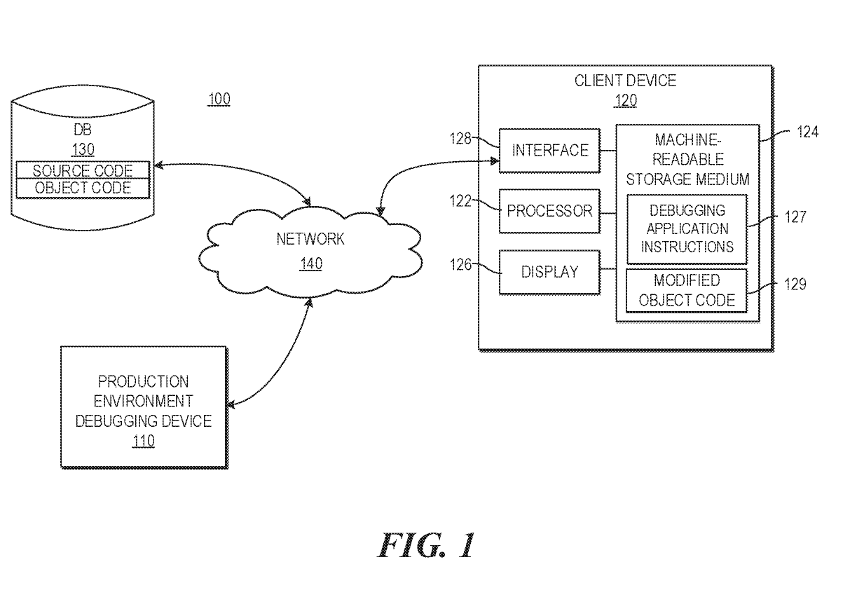

Referring now to the drawings, FIG. 1 is a block diagram of an example system 100 for isolating production environment debugging sessions consistent with disclosed implementations. System 100 may be implemented in a number of different configurations without departing from the scope of the disclosed examples. In the example shown in FIG. 1, system 100 may include a production environment debugging device 110, a client device 120, a database 130, and a network 140 for connecting debugging device 110 with client device 120, database 130, and/or other components not shown in FIG. 1.

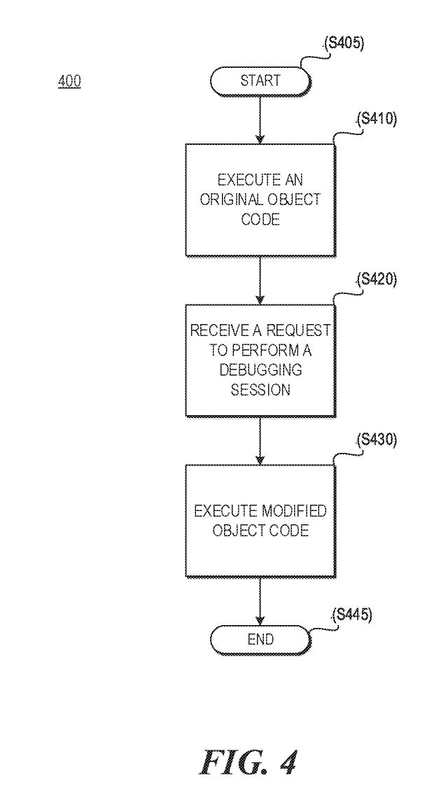

Debugging device 110 may be a computing system that performs various functions consistent with disclosed examples, such as isolating production environment debugging sessions. For example, debugging device 110 may be a server, a desktop computer, a laptop computer, a tablet computing device, a mobile phone, and/or any other type of computing device. In some examples, debugging device 110 may process information received from client device 120, database 130, and/or another device. For example, debugging device 110 may access source code, object code, data values, modified object code and/or other data from database 130. In some examples, debugging device 110 may be separate from the production environment, while in other examples debugging device 110 may be part of or entirely constitute the production environment. In some examples, debugging device 110 may execute object code, receive and/or authenticate debug session initiation requests, receive modified object code, and/or execute the modified object code in isolation such that the executed modified object code is dedicated to the session that initiated the debug request. Examples of debugging device 110 and certain functions that may be performed by debugging device 110 are described in greater detail below with respect to, for example, FIGS. 4 and 6-8.

Client device 120 may be a computing system operated by a user. For example, client device 120 may be a desktop computer, a laptop computer, a tablet computing device, a mobile phone, a server, and/or any other type of computing device. In some examples, client device 120 may be a computing device that performs operations consistent with certain disclosed implementations. For example, client device 120 may be adapted to receive a unit of production environment source code (e.g., a real-time copy of production environment source code) from debugging device 110, modify the unit of production environment source code (e.g., changing code, parameters, and/or data values), compile the modified unit of production environment source code to create modified object code, and transmit the modified object code to debugging device 110.

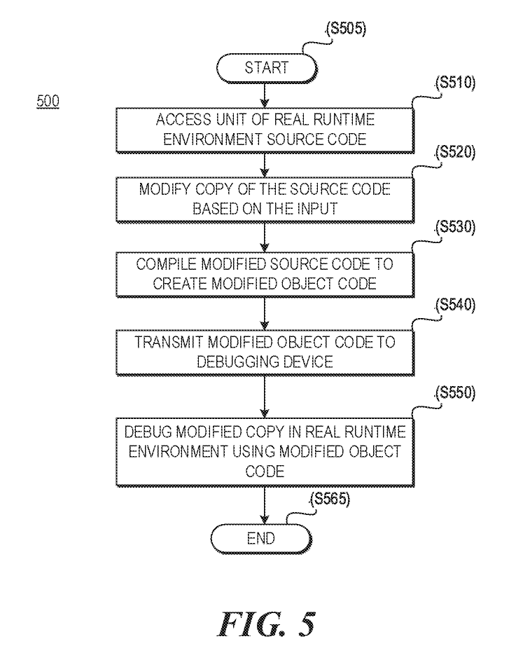

Client device 120 may include a processor to execute instructions stored in a machine-readable storage medium. In the example shown in FIG. 1, client device 120 may include a processor 122, a machine-readable storage medium 124, a display device 126, and an interface 128. Processor 122 of client device 120 may be at least one processing unit (CPU), microprocessor, and/or another hardware device to execute instructions to perform operations. For example, processor 122 may fetch, decode, and execute instructions stored in machine-readable storage medium 124 (such as debugging application instructions 127) to display the accessed copy of production environment source code, modify a local version of the accessed copy, compile the version at client device 120 to create the modified object, store the modified object code 129 in a storage device, such as machine-readable storage medium 124, and/or collect and/or transmit data associated with the modified source code and/or the modified object code. Machine-readable storage medium 124 may be any electronic, magnetic, optical, or other non-transitory storage device that stores instructions executed by processor 122. Display device 126 may be any type of display device that presents information, such as a user interface, to a user operating client device 120. Interface device 128 may be any combination of hardware and/or programming that facilitates the exchange of data between the internal components of client device 120 and external components, such as debugging device 110. In some examples, interface device 128 may include a network interface device that allows client device 120 to receive and send data to and from debugging device 110, database 130, and/or other components via network 140. Examples of client device 120 and certain functions that may be performed by client device 120 are described in greater detail below with respect to, for example, FIGS. 4 and 5.

Database 130 may be any type of storage system configuration that facilitates the storage of data. For example, database 130 may facilitate the locating, accessing, and retrieving of data (e.g., SaaS, SQL, Access, etc. databases). Database 130 can be populated by a number of methods. For example, debugging device 110 may populate database 130 with database entries generated by debugging device 110, and store the database entries in database 130. As another example, debugging device 110 may populate database 130 by receiving a set of database entries from another component, a wireless network operator, and/or a user of client device 120, and storing the set of database entries in database 130. The database entries can contain a plurality of fields, which may include information related to debugging sessions, such as a debugging session name, identifier, status, start time, user name, duration, and the like. In addition to debugging session database entries, database 130 may store real-time versions of the production environment source code, production environment object code, and/or modified object code. While in the example shown in FIG. 1 database 130 is a single component external to components 110 and 120, database 130 may comprise separate databases and/or may be part of devices 110, 120, and/or another device. In some implementations, database 130 may be managed by components of device 110 that are capable of accessing, creating, controlling and/or otherwise managing data remotely through network 140.

Network 140 may be any type of network that facilitates communication between remote components, such as debugging device 110 and client device 120. For example, network 140 may be a local area network (LAN), a wide area network (WAN), a virtual private network, a dedicated intranet, the Internet, and/or a wireless network.

The arrangement illustrated in FIG. 1 is simply an example, and system 100 may be implemented in a number of different configurations. For example, while FIG. 1, shows one debugging device 110, client device 120, database 130, and network 140, system 100 may include any number of components 110, 120, 130, and 140, as well as other components not depicted in FIG. 1. System 100 may also omit any of components 110, 120, 130, and 140. For example, debugging device 110 and database 130 may be directly connected instead of being connected via network 140.

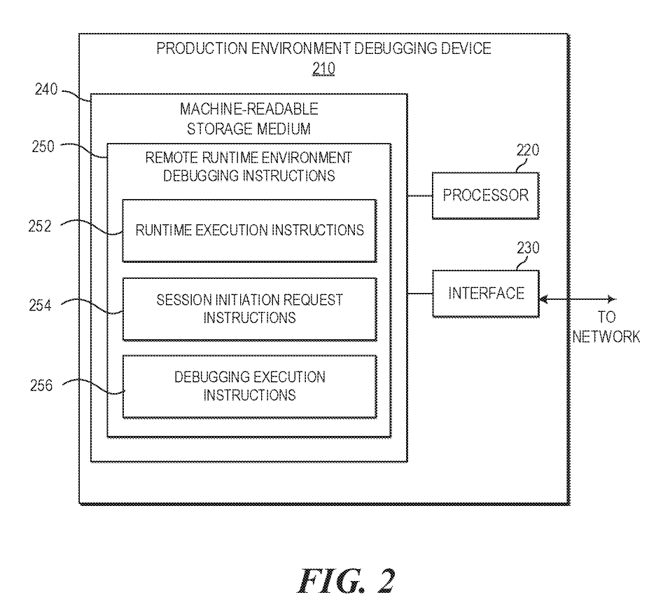

FIG. 2 is a block diagram of an example production environment debugging device 210 consistent with disclosed implementations. In certain aspects, debugging device 210 may correspond to debugging device 110 of FIG. 1. Debugging device 210 may be implemented in various ways. For example, debugging device 210 may be a special purpose computer, a server, a mainframe computer, a computing device executing instructions that receive and process information and provide responses, and/or any other type of computing device. In the example shown in FIG. 2, debugging device 210 may include a processor 220, an interface 230, and a machine-readable storage medium 240.

Processor 220 may be at least one processing unit (CPU), microprocessor, and/or another hardware device to execute instructions to perform operations. For example, processor 220 may fetch, decode, and execute production environment debugging instructions 250 (e.g., instructions 252, 254, and/or 256) stored in machine-readable storage medium 240 to perform operations related to disclosed examples.

Interface device 230 may be any device that facilitates the transfer of information between device 210 and external components, such as client device 120. In some examples, interface device 230 may include a network interface device that allows device 210 to receive and send data to and from network 140. For example, interface device 230 may receive and process modified object code transmitted by client device 120 to debugging device 210 via network 140.

Machine-readable storage medium 240 may be any electronic, magnetic, optical, or other physical storage device that stores executable instructions. Thus, machine-readable storage medium 240 may be, for example, Random Access Memory (RAM), Electrically-Erasable Programmable Read-Only Memory (EEPROM), a storage drive, an optical disc, and the like. In some implementations, machine-readable storage medium 240 may be a non-transitory computer-readable storage medium, where the term “non-transitory” does not encompass transitory propagating signals. Machine-readable storage medium 240 may be encoded with instructions that, when executed by processor 220, perform operations consistent with disclosed implementations. For example, machine-readable storage medium 240 may include instructions that, when executed by a processor, perform operations that may execute a modified object code in isolation in a production environment. In the example shown in FIG. 2, machine-readable storage medium 240 may include runtime execution instructions 252, session initiation request instructions 254, and debugging execution instructions 256.

Runtime execution instructions 252 may function execute original object code. For example, when runtime execution instructions 252 are executed by processor 220, runtime execution instructions 252 may cause processor 220 of debugging device 210, processor 122 of client device 120, and/or another processor to execute, in a production environment, an original object code corresponding to a unit of production environment source code. Examples of steps performed when runtime execution instructions 252 are executed by a processor are described in further detail below with respect to, for example, FIG. 4.

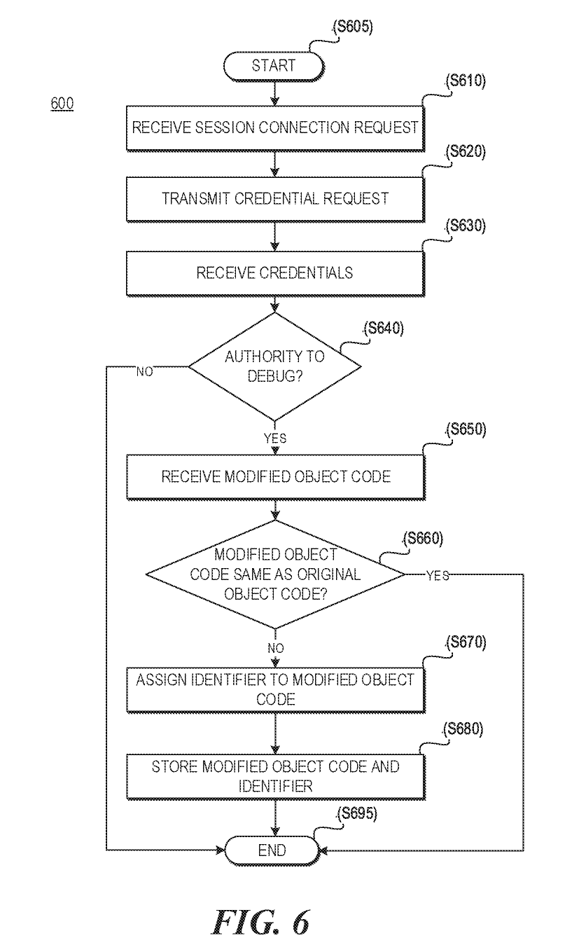

Session initiation request instructions 254 may function to initiate a debugging session. For example, when session initiation request instructions 254 are executed by processor 220, session initiation request instructions 254 may cause the processor 220 of debugging device 210, the processor 122 of client device 120, and/or another processor to receive a request to perform a debugging session of a modified version of a unit of production environment source code. In some examples, the request may include a modified object code corresponding to a machine-readable translation of the modified source code. In some implementations, when session initiation request instructions 254 are executed by processor 220, session initiation request instructions 254 may cause the processor 220 of debugging device 210, the processor 122 of client device 120, and/or another processor to authenticate the authority of the debugging session to debug the modified source code and/or assign an identifier to the modified object code. Examples of steps performed when session initiation request instructions 254 are executed by a processor are described in further detail below with respect to, for example, FIGS. 4 and 6.

Debugging execution instructions 256 may function to debug the modified version of the unit of production environment source code in isolation. For example, when debugging execution instructions 256 are executed by a processor, such as processor 220 of debugging device 210, debugging execution instructions 256 may cause processor 220 of debugging device 210, processor 122 of client device 120, and/or another processor to execute the modified object code in isolation in the production environment. In some examples, the modified object code may be executed without altering at least one of the unit of production environment source code and the original object code. Examples of steps performed when debugging execution instructions 256 are executed by a processor are described in further detail below with respect to, for example, FIGS. 4, 7, and 8.

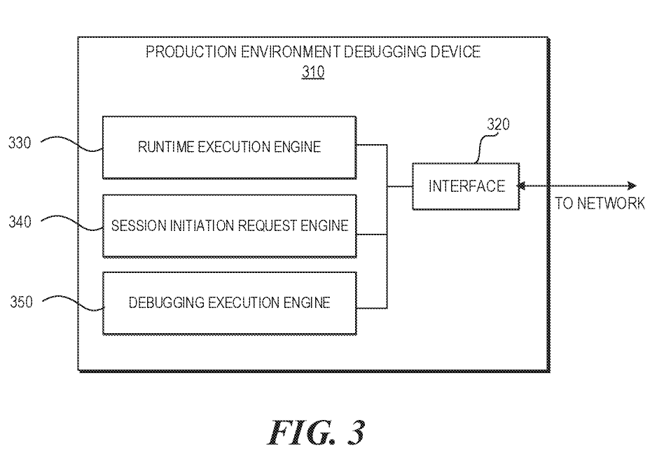

FIG. 3 is a block diagram of an example production environment debugging device 310 consistent with disclosed implementations. In certain aspects, debugging device 310 may correspond to debugging device 110 of FIG. 1 and/or debugging device 210 of FIG. 2. Device 310 may be implemented in various ways. For example, device 310, may be a special purpose computer, a server, a mainframe computer, a computing device executing instructions that receive and process information and provide responses, and/or any other type of computing device. In the example shown in FIG. 3, device 310 may include an interface device 320, a runtime execution engine 330, a session initiation request engine 340, and a debugging execution engine 350.

Interface device 320 may be any device that facilitates the transfer of information between debugging device 310 and external components, such as client device 120. In some examples, interface device 320 may include a network interface device that allows debugging device 310 to receive and send data to and from network 140. For example, interface device 320 may process and transmit data related to a debugging session to client device 120 via network 140.

Engines 330, 340, and 350 may be electronic circuitry for implementing functionality consistent with disclosed examples. For example, engines 320, 330, and 340 may represent combinations of hardware devices and programming to implement the functionality consistent with disclosed implementations. For example, the programming for the engines may be processor executable instructions stored on a non-transitory machine-readable storage medium and the hardware for the engines may include a processing resource to execute those instructions. While engines 330, 340, and 350 are illustrated separately in FIG. 3, engines 330, 340, and 350 may be implemented using the same components and/or combinations of hardware and programming. Furthermore, the functionality of engines 330, 340, and 350 may co-exist or be distributed among several geographically dispersed locations.

In some examples, the functionality of engines 330, 340, and 350 may correspond to operations performed by debugging device 210 of FIG. 2, such as operations performed when production environment debugging instructions 250 are executed by processor 220 (described above with respect to FIG. 2). In FIG. 3, runtime execution engine 330 may represent a combination of hardware and programming that performs operations similar to those performed when processor 220 executes runtime execution instructions 252. Similarly, session initiation request engine 340 may represent a combination of hardware and programming that performs operations similar to those performed when processor 220 executes session initiation request instructions 254, and debugging execution engine 350 may represent a combination of hardware and programming that performs operations similar to those performed when processor 220 executes debugging execution instructions 256.

FIG. 4 is a flow chart of an example process 400 for isolating production environment debugging sessions consistent with disclosed implementations. Although execution of process 400 is described below with reference to system 100 of FIG. 1 and/or specific components of system 100, other suitable systems and devices for execution of at least one step of process 400 may be used. For example, processes described below as being performed by debugging device 110 may be performed by debugging device 210, debugging device 310, and/or any other suitable device. Process 400 may be implemented in the form of executable instructions stored on a machine-readable storage medium and/or in the form of electronic circuitry.

After process 400 starts (step S405), process 400 may include executing an original object code (step S410) that corresponds to a unit of production environment source code. Generally, source code and object code refer to the “before” and “after” versions of applications that are compiled before being executed by a computing system. For example, the source code may consist of programming statements that are created by a programmer with a text editor or a visual programming tool and then saved in a file. The source code may be compiled using a compiler. A compiler may be considered to be a program that translates source code (e.g., a source code file) into object code (e.g., an object code file). The object code may contain a sequence of machine-readable instructions that a processing device can understand, but that may be difficult for a human to read or modify. For example, a compiler may compile source code procedures to create an object code that contains discrete blocks of machine instructions for each procedure in the source code. Thus, in some examples, device 110 may execute an original object code by accessing a real-time unit of production environment source code (“original source code”) from a storage device, such as database 130, compiling the original source code to create the original object code, and executing the original object code using a processing resource (e.g., a processor).

Process 400 may also include receiving a request to perform a debugging session (step S420) of a modified version of the unit of production environment source code. In some implementations, the request may include a modified object code corresponding to a machine-readable translation of modified source code. For example, debugging device 110 may receive a request to perform the debugging session by connecting with client device 120, authenticating that client device 120 and/or the user of client device 120 is authorized to perform the debugging session, and/or receiving the modified object code from client device 120 if debugging device 110 authenticates client device 120 and/or the user of client device 120. The modified object code may contain discrete blocks of machine instructions for each procedure in the unit of modified source code as well as debugging information (defined breakpoints, etc.). Examples of steps involved with receiving a request to perform a debugging session are discussed in greater detail below with respect to, for example, FIG. 6.

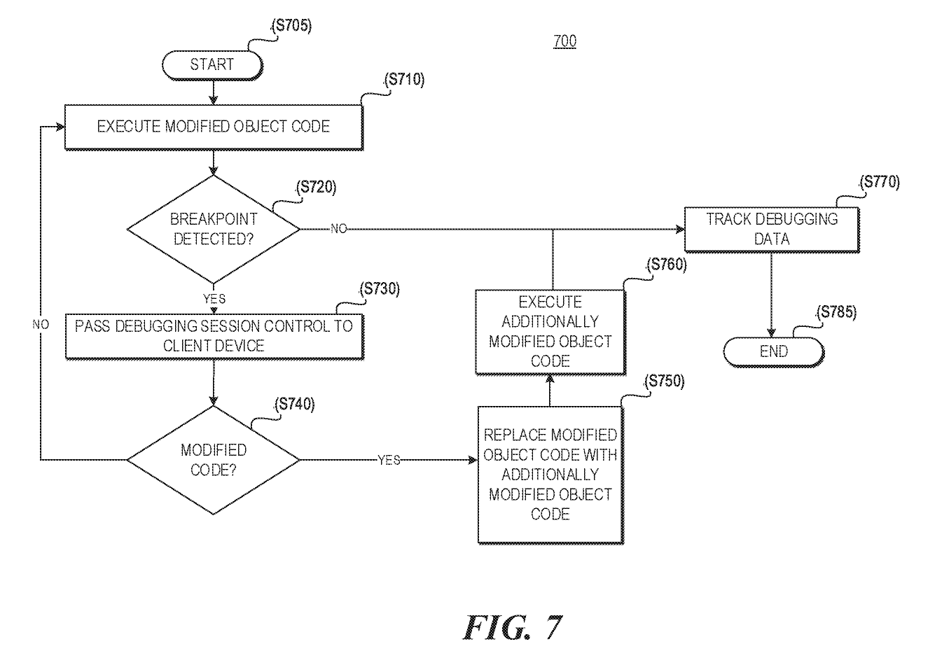

Process 400 may also include executing the modified object code in isolation (step S430). For example, debugging device 110 may execute the modified object code in isolation in the production environment without altering at least one of the unit of production environment source code and the original object code. In some implementations, debugging device 110 may execute the modified object code in isolation by assigning the debugging session and/or the modified object code an identifier, controlling the execution of the modified object code until reaching a detected breakpoint, passing the control to client device 120 in response to the detected breakpoint, receiving an additionally modified object code (e.g., an additionally modified execution plan) from client device 120, and/or continuing the debugging session by executing the additionally modified object code until the code ends and/or reaching a detected breakpoint. Examples of steps that may be involved with executing the modified object code in isolation are discussed in greater detail below with respect to, for example, FIG. 7.

After the original object is executed (step S410), the request to perform a debugging session is received (step S420), and the modified object code is executed (step S430), process 400 may end (step S445).

In an example use case of process 400, the original source code may include the procedures of pinging a computing device to determine whether the computing device is accessible, restarting the computing device remotely, and pinging the computing device again until receiving a response. A system administrator may know that the production environment includes 10 problematic computing devices that need a daily restart. Accordingly, the administrator may trigger execution of an original object code corresponding to the original source code on each of these computing devices at 2:00 a.m. Thus, the production environment may be executing 10 instances of the original object code in parallel at 2:00 a.m. (i.e., one instance per problematic computing device).

A debugger may desire to debug the original source code. For example, the debugger may desire to add a third ping to the source code. At the same time, however, the administrator does not want the debugging to affect how the 10 machines are being handled at 2:00 a.m. in the production environment. Accordingly, the debugger may access the original source code using a client device, modify a local copy of it using the client device, and compile it at the client device to create modified object code. The client device may initiate a debugging session with a server responsible for triggering executions in the production environment and transmit the modified object code to the server. The server may execute the modified object code in the production environment. For example, the server may execute an additional (e.g., an 11^{th}) instance of the original object code in the production environment. In some instances, the modified object code may be executed while executing the original object code.

FIG. 5 is a flow chart of an example process 500 for creating modified object code consistent with disclosed implementations. Although execution of process 500 is described below with reference to system 100 of FIG. 1 and/or specific components of system 100, other suitable systems and devices for execution of at least one step of process 500 may be used. For example, processes described below as being performed by client device 120 may be performed debugging device 110, debugging device 210, debugging device 310, and/or any other suitable device. Process 500 may be implemented in the form of executable instructions stored on a machine-readable storage medium and/or in the form of electronic circuitry.

After process 500 starts (step S505), client device 120 may access a unit of production environment source code (step S510). For example, client device 120 may access the unit of production environment source code from a storage device, such as machine-readable storage medium 124, database 130 and/or the like. As another example, client device 120 may receive a copy of the unit of production environment source from debugging device 110. In some implementations, the unit of production environment source code may be a real-time copy of the source code that is being executed in the production environment.

Process 500 may also include modifying the copy of the source code (step S520). In some examples, the source code may be modified based on a user input. For example, the user input may include modifications to a copy of the source code and/or may include the creation of debugging information related to debugging the source code. For example, users can modify the source code copy by changing (e.g., manually entering and/or modifying) data values, inserting, removing, and/or modifying execution procedures, adding steps to a work flow, changing navigation rules between existing work flow steps, removing steps from a work flow, and the like. As another example, users can modify the debugging information by creating breakpoints, overriding system settings, overriding calculated outputs (e.g., creating modified debugging values), and the like. Users can input the source code modifications and/or the debugging information by interacting with a debug session interface executing on client device 120. For example, users may interact with the interface by executing a mouse click, moving a mouse, typing on a keyboard, executing a touch gesture on a touch-enabled display, executing a voice command, and/or providing information using any other type of input device. After receiving the input, client device 120 may modify the copy of the unit of production environment source code based on the input to create a modified unit of production environment source code. The modified source code is separate and distinct from the original production environment source code such that a dedicated copy of the original source code is maintained. The modified source code and/or the debugging information may be stored in a storage device (e.g., machine-readable storage medium 124, database 130, etc.) and/or transmitted to another device or component for additional processing (e.g., debugging device 110).

Process 500 may also include compiling the modified source code to create a modified object code (step S530) capable of being run by the production environment. For example, client device 120 may include a modified object code creation engine (e.g., a modified execution plan creation engine) that creates the modified object code (e.g., the modified execution plan) by compiling the modified version of a unit of production environment source code. The modified object code creation engine may be electronic circuitry for implementing functionality consistent with disclosed examples. For example, modified object code creation engine may be processor-executable instructions (e.g., debugging application instructions 127 of client device 120) stored on a non-transitory machine-readable storage medium (e.g., machine-readable storage medium 124 of client device 120) and the hardware for the engines may include a processing resource (e.g., processor 122) to execute those instructions. In some implementations, the modified object code creation engine may translate the modified source code into a modified object code. For example, the modified object code may contain machine instructions for each procedure in the modified source code and/or the associated debugging information. For example, the modified source code may be a work flow and the modified object code may be an execution plan. A work flow may be considered to be user-readable representation of a process and an execution plan may be considered to be a machine-readable representation of the work flow. An original work flow may be considered to be a user-readable representation of a process represented by source code in the production environment, and thus may correspond to a unit of production environment source code.

Process 500 may also include transmitting the modified object code to a debugging device (step S540). For example, client device 120 may initiate a debugging session by connecting with debugging device 110 via network 140. In some instances, client device 120 may connect with debugging device 110 using information gathered through the debug session interface described above with respect to step S520. For example, a user of client device 100 may input the uniform resource locator (“URL”) of the debugging device 110 into the debug session interface. When debugging application instructions 127 are executed by processor 122 of client device 120, the application instructions 127 may cause process 122 to connect with and/or otherwise access debugging device 110 using the inputted URL. Concurrently with and/or in response to the connection of client device 120 with debugging device 110 (and, in some instances, before or after an authentication process discussed in further detail below with respect to, for example, FIG. 6), client device 120 may transmit the modified object code to debugging device 110 via network 140.

Process 500 may also include debugging the modified unit of production environment source code using the modified object code (step S550). For example, debugging device 110 may execute the modified object code. Examples of steps that may be involved with debugging the modified unit of production environment source code are described in greater detail below with respect to, for example, FIG. 7. After the modified unit of production environment source code has been debugged, process 500 may end (step S565).

FIG. 6 is a flow chart of an example process 600 for receiving a request to perform a debugging session of a modified version of a unit of production environment source code consistent with disclosed implementations. Although execution of process 600 is described below with reference to system 100 of FIG. 1 and/or specific components of system 100, other suitable systems and devices for execution of at least one step of process 600 may be used. For example, processes described below as being performed by debugging device 110 may be performed by client device 120, debugging device 210, debugging device 310, and/or any other suitable device. Process 600 may be implemented in the form of executable instructions stored on a machine-readable storage medium and/or in the form of electronic circuitry. In certain aspects, process 600 may relate to the processes associated with step S420 of FIG. 4.

Process 600 may start (step S605) after a request to initiate a debugging session has been transmitted by a client device. For example, process 600 may start after client device 120 transmits a connection request to debugging device 110 (e.g., step S540 of FIG. 5). Debugging device 110 may receive the request to connect (step S610) and, in response to the request to connect, may transmit a request for credentials (step S620). For example, debugging device 110 may transmit a request for credentials to client device 120 requesting a user name and password. In some implementations, application instructions 127, when executed by processor 122, may cause processor 122 to display the request for credentials on display device 126 of client device 120 using the debug session interface described above. In some examples, a user may input credentials to client device 120 using an input device, and the inputted credentials may be transferred by client device 120 to debugging device 110 via network 140.

Process 600 may include receiving the credentials (step S630) transmitted by client device 120 and, in response to receiving the credentials, authenticating the authority of the debugging session to debug the modified version of the production environment source code (step S640). For example, debugging device 110 may compare the transmitted credentials with a list of stored credentials to determine whether the transmitted credentials match the list of stored credentials. If the authority of the debugging session is not authenticated (e.g., the transmitted credentials do not match the list of stored credentials) (step S640; no), process 600 may end (step S695). If the authority of the debugging session is authenticated (e.g., the transmitted credentials match the list of stored credentials) (step S640; yes), debugging device 110 may receive the modified object code (step S650). For example, in some implementations debugging device 110 may prevent transmission of the modified object code and/or otherwise not accept a transmission of the modified object code until the debugging session has been authenticated.

Process 600 may also include comparing the modified object code to the original object code (step S660). For example debugging device 110 may compare the modified object code to the original object code by determining if there are any differences between the modified object code and the original object code (e.g., whether a modified execution plan is the same as an original execution plan). If there are not any differences (step S660; no), process 600 may end (step S695). If there are differences (step S660; yes), debugging device may assign an identifier to the modified object code (step S670). For example, each debugging session may have an identifier (e.g. a unique identifier) which may be generated by debugging device 110 in response to the session connection request. Debugging device 110 may determine the identifier of the debugging session, and assign the identifier to the modified object code. The modified object code and the identifier may be stored in a storage device, such as database 130, in a manner that links the modified object code with the identifier (step S680). After the modified code and/or the identifier are stored, process 600 may end (step S695).

FIG. 7 is a flow chart of an example process 700 for executing modified object code in isolation consistent with disclosed implementations. Although execution of process 700 is described below with reference to system 100 of FIG. 1 and/or specific components of system 100, other suitable systems and devices for execution of at least one step of process 700 may be used. For example, processes described below as being performed by debugging device 110 may be performed by client device 120, debugging device 210, debugging device 310, and/or any other suitable device. Process 700 may be implemented in the form of executable instructions stored on a machine-readable storage medium and/or in the form of electronic circuitry. In certain aspects, process 700 may relate to the processes associated with step S430 of FIG. 4.

Process 700 may start (step S705) after the modified object code has been received. In some examples, process 700 may include executing the modified object code (step S710) in isolation. For example, debugging device 110 may bypass the original object code and execute the modified object code in isolation by dedicating the execution of the modified object code to the debugging session that transmitted it. For example, debugging device 110 may dedicate the execution of the modified object code to the debugging session that transmitted it by ensuring that steps executed in this specific debugging session are read from the object code that was associated with it (e.g., associated with it through an identifier). Thus, in some examples, a first modified object code will only be executed for a first debug session, a second modified object code will only be executed for a second debug session, and the like. In some examples, the modified object code may be executed by the production environment while the production environment is executing the original object code. For example, debugging device 110 may execute at least one instance of the original object code. For example, debugging device 110 may execute a plurality of instances of the original object code for a plurality of client devices in the production environment. At the same time, in some implementations, debugging device 110 may execute at least one instance of the modified object code. For example, debugging device 110 may execute a modified object code for a single client device of the plurality of client devices. Thus, in some examples, the modified object code can be executed at the same time in the production environment without altering the unit of production environment source code and/or the original object code. Additionally, in some implementations, during execution, the modified object code may obtain production environment data values from the production environment for use during debugging, and the debugging session may be executed using the production environment data values. For example, system settings (e.g., a target machine to run a specific operation against, a database URL to persist information in, etc.) may be retrieved from the production environment and/or set specifically for the debugging session as part of an additional modification to the debugging information.

Process 700 may include executing the modified object code until reaching a detected breakpoint (step S720). For example, debugging device 110 may detect breakpoints in the debugging session based on the modified object code. In response to detecting a breakpoint (step 720; yes), debugging device 110 may pass control of the debugging session to client device 120 (step S730). In some examples, while client device 120 has control of the debugging session, a user operating client device 120 may provide additional modifications to the unit of production environment source code (e.g., an additionally modified copy), compile the additional modifications to create an additionally modified object code (e.g., an additionally modified execution plan), and/or pass the control of the debugging session back to debugging device 110. Debugging device 110 may determine if the client device additionally modified the modified object code (step S740). If not (step S740; no), debugging device 110 may continue with executing the modified object code. If so, (step S740; yes), debugging device 110 may replace the modified object code with the additionally modified object code (step S750) and execute the additionally modified object code (step S760). Although not shown in FIG. 7, in some examples, process 700 may also return to step S720 after completing step S760 to determine if there are any breakpoints in the additionally modified object code.

If debugging device 110 does not detect a breakpoint (step S720; no), process 700 may include tracking debugging session data (step S770). For example, debugging device 110 may track debugging session data using an identifier associated with the debugging session, an identifier associated with the modified object code, information related to the user and/or the like. The debugging session data may include, for example, the date and time of the debugging session, the user associated with the debugging session, the identifier associated with the modified object code, the identifier associated with the debugging session, the name of the debugging session, the duration of the debugging session, whether the debugging session included code replacement, the result of the debugging session (e.g., success, failure, etc.) and/or any other information related to the debugging session. In some examples, debugging device 110 may provide the debugging session data to a storage device, such as database 130, and/or to another component for additional processing. After the debugging data is tracked, process 700 may end (step S785).

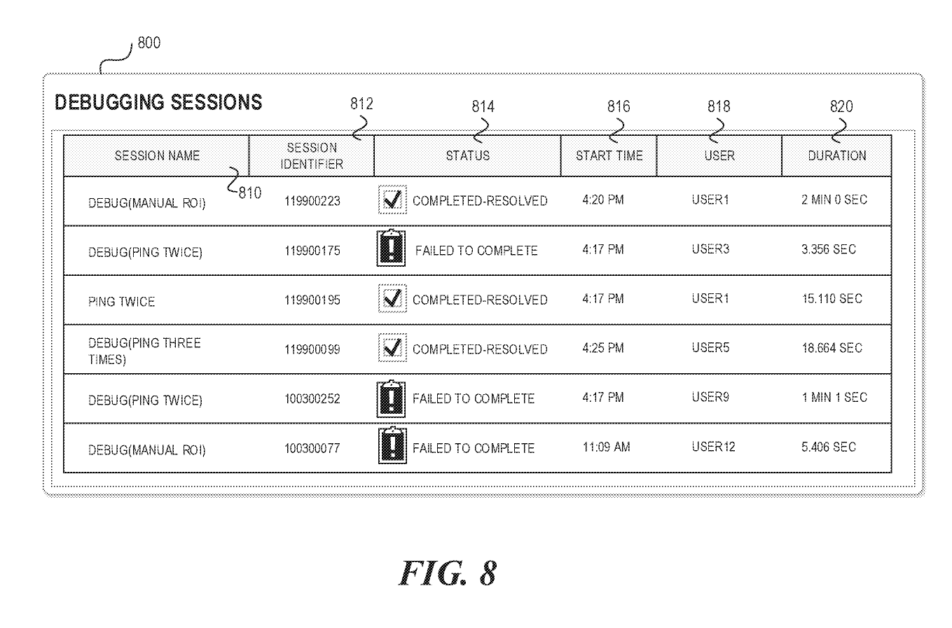

FIG. 8 is an example of a user interface 800 for displaying tracked debugging data consistent with disclosed implementations. In some examples, user interface (“UI”) 800 may be generated by device 110 using data obtained from, for example, a machine-readable medium, a database, and/or another component. For example, device 110 may obtain the tracked debugging data described above with respect to step S760 of FIG. 7 from database 130 and use the tracked data to generate UI 800.

As shown in FIG. 8, UI 800 may display tracked debugging data as text, graphics, or a combination of text and graphics in a way that aids the user in tracking debugging sessions and debugging session results. For example, as shown in FIG. 8, UI 800 may include an area 810 for displaying the name of the session, an area 812 for displaying the identifier (e.g., the identifier assigned to the modified object code), an area 814 for displaying the status, an area 816 for displaying the session start time, an area 818 for displaying the user that initiated the session, and an area 820 for displaying the session duration. As shown in FIG. 8, debugging device 110 may allow for execution of original object code at the same time as modified object code. For example, at 4:17 p.m., a modified object corresponding to a unit of production environment source code (i.e., “PING TWICE” in this example) was executed by session 119900195 at the same time as two debugging sessions were executing modified object codes (i.e., sessions 119900175 and 100300252).

The user interface displayed in FIG. 8 is simply an example, and disclosed embodiments may display tracked debugging data using a different type of interface. For example, user interfaces consistent with disclosed examples may display different types of tracked debugging data than that shown in FIG. 8. As another example, user interfaces consistent with disclosed examples may limit the information shown to a particular user, client device, operating system, and the like.

The disclosed examples may include systems, devices, computer-readable storage media, and methods for isolating production environment debugging sessions. For purposes of explanation, certain examples are described with reference to the components illustrated in FIGS. 1-3. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Additionally, as used in the specification and the appended claims, the singular forms “a,” “an,” and “the” are intended to include the plural forms as well, unless the context indicates otherwise. Moreover, although the terms first, second, etc. may be used herein to describe various elements, these elements should not be limited by this terms. Instead, these terms are used to distinguish one element from another.

Further, the sequence of operations described in connection with FIGS. 1-8 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order, including those in FIGS. 4-7. Thus, the present disclosure merely sets forth possible examples of implementations, and many variations and modifications may be made to the described examples. All such modifications and variations are intended to be included within the scope of this disclosure and protected by the following claims.

We claim:

1. A system for isolating production environment debugging sessions comprising:
a runtime execution engine to execute, in a production environment, an original work flow corresponding to a unit of production environment source code;
a session initiation request engine to receive a request to perform a debugging session of a modified version of the unit of production environment source code, the request including a modified execution plan corresponding to a machine-readable translation of the modified version; and
a debugging execution engine to execute the modified execution plan in isolation, the modified execution plan being executed in the production environment without altering at least one of the unit of production environment source code and the original work flow.

2. The system of claim 1, wherein executing the modified execution plan in isolation includes:
dedicating the execution of the modified execution plan to the debugging session;
executing the modified execution plan during an execution of an instance of the original work flow;
obtaining production environment data values; and
executing the debugging session using the production environment data values and manually entered data values.

3. The system of claim 1, wherein:
executing the original work flow comprises executing at least one instance of the original work flow; and
executing the modified execution plan in isolation comprises executing at least one instance of the modified execution plan.

4. The system of claim 1, wherein:
the session initiation request engine authenticates the authority of the debugging session to debug the modified version of the unit of production environment source code; and
the debugging execution engine:
executes the modified execution plan if the authority of the debugging session is authenticated;
detects breakpoints in the debugging session based on the modified execution plan; and
executes the modified execution plan until reaching a detected breakpoint.

5. The system of claim 4, wherein:
the debugging execution engine controls the execution of the modified execution plan until reaching the detected breakpoint;
in response to reaching the detected breakpoint, the debugging execution engine passes control of the debugging session to a client device, the client device initiating the request;
in response to passing control of the debugging session to the client device, the debugging execution engine receives a modified debugging value from the client device; and
the debugging execution engine continues the execution of the modified execution plan using the modified debugging value.

6. The system of claim 1, wherein the unit of production environment source code is a real-time version of the production environment source code.

7. The system of claim 1, wherein:
the debugging session is a first debugging session;
the modified execution plan is a first modified execution plan;
the session initiation request engine receives a request to perform a debugging session of a second modified version of the unit of production environment source code, the second request including a second modified execution plan corresponding to a machine-readable translation of the second modified version; and
the debugging execution engine executes the second modified execution plan in isolation, the second modified execution plan being executed at the same time as the first modified execution plan without altering the first modified execution plan, the unit of production environment source code, and the original work flow.

8. The system of claim 7, wherein the session initiation request engine:
assigns a first identifier to the first modified execution plan;
assigns a second identifier to the second modified execution plan; and
tracks a status of the first debugging session and a status of the second debugging session based on the first identifier and the second identifier.

9. The system of claim 1, further comprising:
a modified execution plan creation engine that creates the modified execution plan by compiling the modified version of the unit of production environment source code.

10. The system of claim 1, wherein the unit of production environment source code is a user-readable work flow.

11. The system of claim 1, wherein a client device additionally modifies the unit of production environment source code.

12. A non-transitory computer-readable storage medium including instructions which, when executed by a processor, cause the processor to:
access a unit of production environment source code, the unit of production environment source code being deployed in a production environment;
modify a copy of the unit of production environment source code;
compile the modified copy to create a modified execution plan capable of being run by the production environment;
transmit the modified execution plan to a debugging device; and
debug the modified copy in the production environment using the modified execution plan, the modified copy being debugged without modifying at least one of the unit of production environment source code or an original work flow corresponding to the unit of production environment source code.

13. The computer-readable storage medium of claim 12, wherein:
the modified copy is compiled at a client device remote to the debugging device; and
debugging the modified copy includes:
receiving control of the debugging session from the debugging device in response to a breakpoint defined in the modified execution plan;
in response to receiving control of the debugging session, additionally modifying the copy of the unit of production environment source code;
compiling the additionally modified copy to create an additionally modified execution plan; and
debugging the modified copy in the production environment using the additionally modified execution plan.

14. A computer-implemented method for isolating debugging sessions in a production environment, the method comprising:
receiving, from a client device, a modified execution plan corresponding to a compiled modified version of production environment source code;
determining, via a processor, if the modified execution plan is the same as an original execution plan; and
if the modified execution plan is not the same as the original execution plan:
assigning, via the processor, an identifier to the modified execution plan;
debugging, via the processor, the modified version of the production environment source code by executing the modified execution plan in a production environment, the modified execution plan being executed only for the client device; and
tracking, via the processor, debugging data based on the identifier.

15. The computer-implemented method of claim 14 comprising generating, via the processor, a display using the tracked debugging data.
